(19) United States
(12) Patent Application Publication
(10) Pub. No.: US 2011/0261766 A1
(43) Pub. Date: Oct. 27, 2011

(54) WLAN DEVICE AND CHANNEL SCANNING METHOD

(75) Inventor: CHENG-WEN TANG, Tu-Cheng (TW)

(73) Assignee: HON HAI PRECISION INDUSTRY CO., LTD., Tu-Cheng (TW)

(21) Appl. No.: 12/826,601

(22) Filed: Jun. 29, 2010

(30) Foreign Application Priority Data
Apr. 26, 2010 (CN) 201010156287.9

(51) Int. Cl. H04W 72/00

(52) U.S. Cl. 370/329

(57) ABSTRACT

A wireless local area network (WLAN) device actively scans a first wireless channel, waits for a first scanning result of the first wireless channel for a first waiting time period, and transmits a first time extending frame to the first wireless channel to extend the first waiting time period. The WLAN device further actively scans a second wireless channel within the first waiting time period, waits for a second scanning result of the second wireless channel for a second waiting time period, and transmits a second time extending frame to the second wireless channel to extend the second waiting time period. The WLAN device receives the first scanning result from the first wireless channel, and then receives the second scanning result from the second wireless channel, after the WLAN device actively scans the first and second wireless channels.

### BACKGROUND

1. Technical Field

Embodiments of the present disclosure relate to wireless local area networks (WLANs), and more particularly to a WLAN device and a channel scanning method.

2. Description of Related Art

In a wireless local area network (WLAN), a mobile station scans a plurality of wireless channels to find a proper wireless channel, and then authenticates and associates with an access point in the proper wireless channel.

Presently, the mobile station often actively scans the plurality of wireless channels. In detail, the mobile station actively scans a first wireless channel, and waits for a first scanning result of the first wireless channel. After receiving the first scanning result, the mobile station continues to actively scan a second wireless channel, and waits for a second scanning result of the second wireless channel. By analogy, the mobile station scans the remaining wireless channels. Thus, the mobile station wastes the time periods for waiting for the scanning results of the plurality of wireless channels.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment and functional modules of one embodiment of a wireless local area network (WLAN) device in accordance with the present disclosure;

FIG. 2 is a flowchart of one embodiment of a channel scanning method in accordance with the present disclosure; and

FIG. 3 is a flowchart of another embodiment of a channel scanning method in according with the present disclosure.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

As used herein, the terms “probe request frame”, “probe response frame”, “data frame”, “management frame”, “control frame”, and “request to send (RTS) frame” are all defined by the IEEE 802.11 protocol. According to the IEEE 802.11 protocol, the probe request frame and the probe response frame are two types of management frames. The RTS frame is one type of control frame.

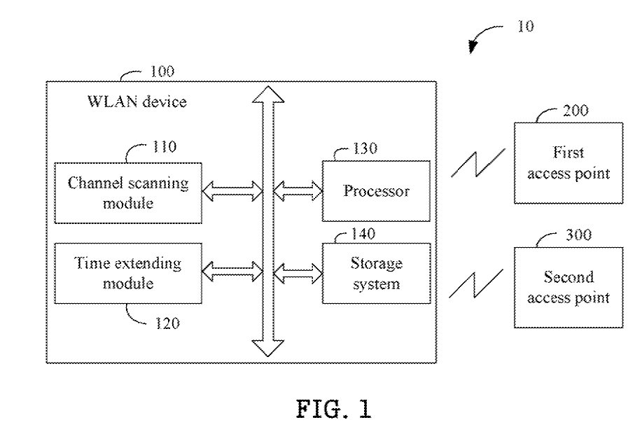

FIG. 1 is a schematic diagram of an application environment and functional modules of one embodiment of a wireless local area network (WLAN) device 100 in accordance with the present disclosure. In one embodiment, the WLAN device 100 is located in a WLAN 10 with a plurality of wireless channels. The WLAN 10 includes a first access point 200 and a second access point 300. The first access point 200 and the second access point 300 are network devices that allow mobile stations to connect to the WLAN 10 using WIFI. In other words, the first access point 200 and the second access point 300 provides network access service for mobile stations in the WLAN 10. It should be understood that the mobile stations can be mobile phones, personal computers, notebook computers, or personal digital assistants (PDAs), for example. The WLAN device 100 may be an access point or a mobile station that scans a plurality of wireless channels of the WLAN 10 to find a proper wireless channel.

In one embodiment, the first access point 200 provides network access service for mobile stations in a first wireless channel of the WLAN 10. When the WLAN device 100 broadcasts a first probe request frame in the first wireless channel to actively scan the first wireless channel, the first access point 200 receives the first probe request frame and transmits a first probe response frame back to the WLAN device 100. The first probe response frame includes a usage state of the first wireless channel.

In one embodiment, the second access point 300 provides network access service for mobile stations in a second wireless channel of the WLAN 10. When the WLAN device 100 broadcasts a second probe request frame in the second wireless channel to actively scan the second wireless channel, the second access point 300 receives the second probe request frame and transmits a second probe response frame back to the WLAN device 100. The second probe response frame includes a usage state of the second wireless channel.

When the WLAN device 100 is one mobile station, the WLAN 100 actively scans the plurality of wireless channels of the WLAN 10 to find a proper wireless channel, and then authenticates and associates with one access point in the proper wireless channel, in order to enjoy network access service from the access point in the proper wireless channel. For example, assuming that the WLAN device 100 scans the plurality of wireless channels to find the first wireless channel, the WLAN device 100 will authenticate and associate with the first access point 200 in the first wireless channel, in order to enjoy the network access service from the first access point 200 in the first wireless channel.

When the WLAN device 10 is one access point, the WLAN device 10 scans the plurality of wireless channels to find a proper wireless channel, and provides network access service for mobile stations in the proper wireless channel, in order to avoid interferences between the WLAN device 10 and other access points. For example, assuming that the WLAN device 100 scans the plurality of wireless channels to find a third wireless channel, the WLAN device 100 provides network access service for mobile stations in the third wireless channel, in order to avoid interferences among the WLAN device 100, the first access point 200, and the second access point 300.

In one embodiment, the WLAN device 100 includes a channel scanning module 110, a time extending module 120, at least one processor 130, and a storage system 140. The modules 110 and 120 may comprise one or more computerized instructions which may be in the storage system 140 and executed by the at least one processor 130.

The channel scanning module 110 is operable to actively scan a first wireless channel of the WLAN 10 and wait for a first scanning result of the first wireless channel for a first waiting time period. In should be understood that the first scanning result is a first probe response frame including a usage state of the first wireless channel. To actively scan the first wireless channel, the channel scanning module 110 broadcasts a first probe request frame in the first wireless channel, and waits for the first probe response frame from the first wireless channel. To broadcast the first probe request frame in the first wireless channel, the channel scanning module 110 transmits the first probe request frame to all WLAN devices within a wireless range of the WLAN device 100. The first access point 200 is within the wireless range of the WLAN device 100, and thereby receives the first probe request frame.

After receiving the first probe request frame, the first access point 200 needs the first waiting time period, such as 5 microseconds (ms), to transmit a first probe response frame back to the channel scanning module 110. Thus, the channel scanning module 110 needs to wait for the first waiting time period to receive the probe response frame.

The first waiting time period is a variable time period, so the channel scanning module 110 may be miss the first probe response frame from the first access point 200 if the channel scanning module 110 utilizes the first waiting time period to scan a next wireless channel.

In order to avoid wasting the first waiting time period and missing the first probe response frame, the first waiting time period is extended to a fixed time period under control of the time extending module 120. In one embodiment, the time extending module 120 transmits a first time extending frame to the first wireless channel to extend the first waiting time period, namely delaying the first probe response frame from the first access point 200.

In one embodiment, the first time extending frame includes a first duration field that loads a first occupied time period of how long the WLAN device 100 occupies the first wireless channel. The time extending module 120 extends the first occupied time period loaded by the first duration field so as to extend the first waiting time period.

According to the carrier sense multiple access/collision detection (CSMA/CD) of the IEEE 802.11 protocol, the first access point 200 needs to wait for the first occupied time period loaded by the first duration field of the first time extending frame to utilize the first wireless channel, after the WLAN device 100 transmits the first time extending frame in the first wireless channel. Thus, the first access point 200 needs to wait for the first occupied time period to transmit the first probe response frame back to the channel scanning module 110 by use of the first wireless channel.

It should be noted that the first occupied time period can be set to different time periods according to different requirements. Assuming that scanning one wireless channel takes 100 ms, the first occupied time period can set to 200 ms (100 ms*2) if the channel scanning module 110 actively scans two wireless channels in sequence and then receives scanning results of the two wireless channels in sequence. The first occupied time period can set to 300 ms (100 ms*3) if the channel scanning module 110 actively scans three wireless channels in sequence and then receives scanning results of the three wireless channels in sequence. By analogy, the first occupied time period can set to (100 ms*N) if the channel scanning module 110 actively scans N wireless channels in sequence and then receives scanning results of the N wireless channels in sequence.

It should be noted that the first time extending frame may be a control frame or a data frame defined by the IEEE 802.11 protocol. In one example, the control frame may be a request to send (RTS) frame defined by the IEEE 802.11 protocol. According to CSMA/CD of the IEEE 802.11 protocol, the control frame and the data frame can be used to occupy one wireless channel for a fixed time period via duration fields of the control frame and the data frame.

In one embodiment, a destination address of the first time extending frame can be set to any address, such as a media access control (MAC) address of the first access point 200 or a MAC address of the second access point 300.

The channel scanning module 110 further actively scans a second wireless channel of the WLAN 10 within the first waiting time period, and waits for a second scanning result of the second wireless channel for a second waiting time period. In one embodiment, the second scanning result is a second probe response frame including a usage state of the second wireless channel. To actively scan the second wireless channel, the channel scanning module 110 broadcasts the second probe request frame in the second wireless channel, and waits for the second probe response frame from the second wireless channel. To broadcast the second probe request frame in the second wireless channel, the channel scanning module 110 transmits the second probe request frame to all WLAN devices within the wireless range of the WLAN device 100. The second access point 300 is within the wireless range of the WLAN device 100, and thereby receives the second probe request frame. After receiving the second probe request frame, the second access point 300 needs the second waiting time period, such as 5 ms, to transmit the second probe response frame back to the channel scanning module 110. The second waiting time period is a variable time period.

In order to avoid wasting the second waiting time period and missing the second probe response frame, the second waiting time period is extended to a fixed time period under control of the time extending module 120. In one embodiment, the time extending module 120 transmits a second time extending frame to the second wireless channel to extend the second waiting time period, namely delaying the second probe response frame from the second access point 300.

In one embodiment, the second time extending frame may be a control frame or a data frame, which includes a second duration field that loads a second occupied time period of how long the WLAN device 100 occupies the second wireless channel. The time extending module 120 extends the second occupied time period to extend the second waiting time period. A destination address of the second time extending frame may be any address, such as the MAC address of the first access point 200 or the MAC address of the second access point 300.

The channel scanning module 110 receives the first scanning result from the first wireless channel, and then receives the second scanning result from the second wireless channel, after the channel scanning module 110 scans at least the first and second wireless channels. In detail, the channel scanning module 110 receives the first probe response frame from the first wireless channel, and then receives the second probe response frame from the second wireless channel.

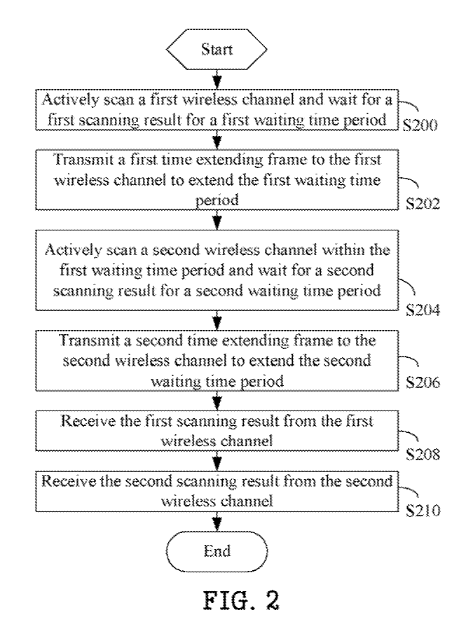

FIG. 2 is a flowchart of one embodiment of a channel scanning method in accordance with the present disclosure. The method is executed by the functional modules of FIG. 1. Depending on the embodiment, additional blocks may be added, others deleted, and the ordering of blocks may be changed while remaining well within the scope of the disclosure.

In this embodiment, the WLAN device 100 actively scans two wireless channels in sequence, and then receives scanning results of the two wireless channels in sequence.

In block S200, the channel scanning module 110 actively scans a first wireless channel of the WLAN 10 and waits for a first scanning result of the first wireless channel for a first waiting time period. In should be understood that the first scanning result is a first probe response frame including a usage state of the first wireless channel. To actively scan the first wireless channel, the channel scanning module 110 broadcasts a first probe request frame in the first wireless channel, and waits for the first probe response frame from the first wireless channel. To broadcast the first probe request frame in the first wireless channel, the channel scanning module 110 transmits the first probe request frame to all WLAN devices within a wireless range of the WLAN device 100. The first access point 200 is within the wireless range of the WLAN device 100, and thereby receives the first probe request frame.

After receiving the first probe request frame, the first access point 200 needs the first waiting time period, such as 5 ms, to transmit the first probe response frame back to the channel scanning module 110. Thus, the channel scanning module 110 needs to wait for the first waiting time period to receive the probe response frame.

In block S202, the time extending module 120 transmits a first time extending frame to the first wireless channel to extend the first waiting time period, namely delaying the first probe response frame from the first access point 200. It should be noted that the first time extending frame includes a first duration field that loads a first occupied time period of how long the WLAN device 100 occupies the first wireless channel. The time extending module 120 extends the first occupied time period to extend the first waiting time period.

In one embodiment, the first occupied time period can be set to different time periods according to different requirements. Assuming that scanning one wireless channel takes 100 ms, the first occupied time period can set to 200 ms (100 ms*2) because the channel scanning module 110 of this embodiment actively scans two wireless channels in sequence and then receives scanning results of the two wireless channels in sequence. It should be understood that the first time extending frame may be a control frame or a data frame defined by the IEEE 802.11 protocol.

In block S204, the channel scanning module 110 actively scans a second wireless channel of the WLAN 10 within the first waiting time period, and waits for a second scanning result of the second wireless channel for a second waiting time period. It should be understood that the second scanning result is a second probe response frame including a usage state of the second wireless channel. To actively scan the second wireless channel, the channel scanning module 110 broadcasts a second probe request frame in the second wireless channel, and waits for the second probe response frame from the second wireless channel. To broadcast the second probe request frame in the second wireless channel, the channel scanning module 110 transmits the second probe request frame to all WLAN devices within the wireless range of the WLAN device 100.

The second access point 300 is within the wireless range of the WLAN device 100, and thereby receives the second probe request frame. After receiving the second probe request frame, the second access point 300 needs the second waiting time period, such as 5 ms, to transmit the second probe response frame back to the channel scanning module 110.

In block S206, the time extending module 120 transmits a second time extending frame to the second wireless channel to extend the second waiting time period, namely delaying the second probe response frame from the second access point 300. It should be noted that the second time extending frame may be a control frame or a data frame, which includes a second duration field that loads a second occupied time period of how long the WLAN device 100 occupies the second wireless channel. The time extending module 120 extends the second occupied time period to extend the second waiting time period. A destination address of the second time extending frame may be any address, such as the MAC address of the first access point 200 or the MAC address of the second access point 300.

In block S208, the channel scanning module 110 receives the first scanning result, namely the first probe response frame, from the first wireless channel.

In block S210, the channel scanning module 110 receives the second scanning result, namely the second probe response frame, from the second wireless channel.

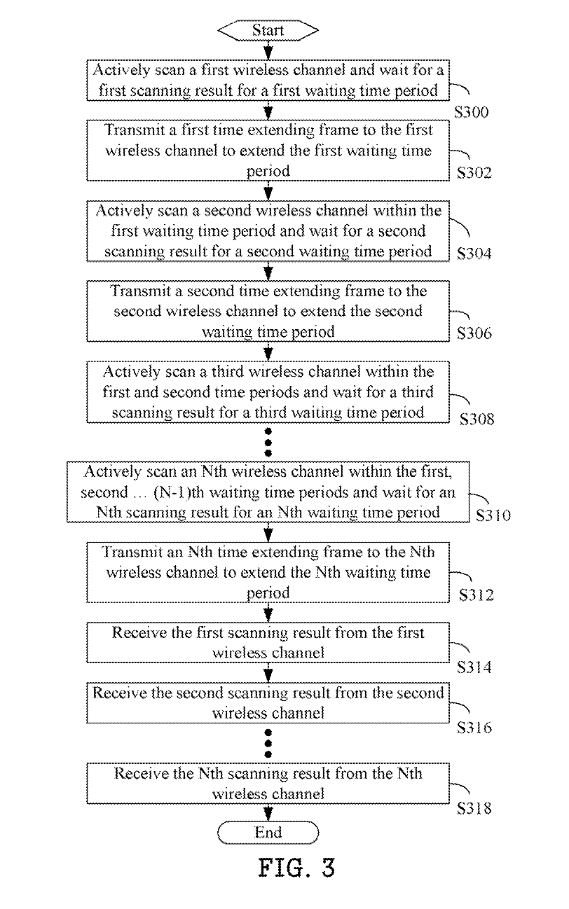

FIG. 3 is a flowchart of another embodiment of a channel scanning method in accordance with the present disclosure. The method is executed by the functional modules of FIG. 1. Depending on the embodiment, additional blocks may be added, others deleted, and the ordering of blocks may be changed while remaining well within the scope of the disclosure.

In this embodiment, the WLAN device 100 actively scans N pieces of wireless channels in sequence and then receives scanning results of the N pieces of wireless channels in sequence.

In block S300, the channel scanning module 110 actively scans a first wireless channel and waits for a first scanning result of the first wireless channel for a first waiting time period. In should be understood that the first scanning result is a first probe response frame including a usage state of the first wireless channel. To actively scan the first wireless channel, the channel scanning module 110 broadcasts a first probe request frame in the first wireless channel, and waits for the first probe response frame from the first wireless channel. To broadcast the first probe request frame in the first wireless channel, the channel scanning module 110 transmits the first probe request frame to all WLAN devices within a wireless range of the WLAN device 100.

The first access point 200 is within the wireless range of the WLAN device 100, and thereby receives the first probe request frame. After receiving the first probe request frame, the first access point 200 needs the first waiting time period, such as 5 ms, to transmit the first probe response frame back to the channel scanning module 110. Thus, the channel scanning module 110 needs to wait for the first waiting time period to receive the probe response frame.

In block S302, the time extending module 120 transmits a first time extending frame to the first wireless channel to extend the first waiting time period, namely delaying the first probe response frame from the first access point 200. It should be noted that the first time extending frame includes a first duration field that loads a first occupied time period of how long the WLAN device 100 occupies the first wireless channel. The time extending module 120 extends the first occupied time period loaded by the first duration field to extend the first waiting time period.

In one embodiment, the first duration field of the first time extending frame can be set to different time periods according to different requirements. Assuming that scanning one wireless channel takes 100 ms, the first duration field of the first time extending frame can set to (100 ms*N) because the channel scanning module 110 of this embodiment actively scans N pieces of wireless channels in sequence and then receives scanning results of the N pieces of wireless channels in sequence.

In block S304, the channel scanning module 110 actively scans a second wireless channel within the first waiting time period, and waits a second scanning result of the second wireless channel for a second waiting time period. It should be understood that the second scanning result is a second probe response frame including a usage state of the second wireless channel. To actively scan the second wireless channel, the channel scanning module 110 broadcasts a second probe request frame in the second wireless channel, and waits for the second probe response frame from the second wireless channel. To broadcast the second probe request frame in the second wireless channel, the channel scanning module 110 transmits the second probe request frame to all WLAN devices within the wireless range of the WLAN device 100.

The second access point 300 is within the wireless range of the WLAN device 100, and thereby receives the second probe request frame. After receiving the second probe request frame, the second access point 300 needs the second waiting time period, such as 5 ms, to transmit the second probe response frame back to the channel scanning module 110.

In block S306, the time extending module 120 transmits a second time extending frame to the second wireless channel to extend the second waiting time period, namely delaying the second probe response frame from the second access point 300.

In block S308, the channel scanning module 120 actively scans a third wireless channel of the WLAN 10 within the first and second waiting time periods, and waits for a third scanning result of the third wireless channel for a third waiting time period.

By analogy, in block S310, the channel scanning module 120 actively scans a Nth wireless channel of the WLAN 10 within the first, second, . . . , (N−1)th waiting time periods, and waits for an Nth scanning result of the Nth wireless channel for an Nth waiting time period.

In block S312, the time extending module 120 transmits an Nth time extending frame to the Nth wireless channel to extend the Nth waiting time period.

In block S314, the channel scanning module 110 receives the first scanning result from the first wireless channel.

In block S316, the channel scanning module 110 receives the second scanning result from the second wireless channel.

By analogy, in block S318, the channel scanning module 110 receives the Nth scanning result from the Nth wireless channel.

In general, the WLAN device 100 actively scans a next wireless channel within the time period for waiting for each scanning result of each wireless channel. Thus, the time period for waiting for each scanning result of each wireless channel is used efficiently, so a total time period for scanning all the wireless channels is reduced.

While various embodiments of the present disclosure have been described above, it should be understood that they have been presented using example only and not using limitation. Thus the breadth and scope of the present disclosure should not be limited by the above-described embodiments, but should be defined only in accordance with the following claims and their equivalents.

What is claimed is:

1. A wireless local area network (WLAN) device located in a WLAN with a plurality of wireless channels, the WLAN device comprising:
one or more processors;
a storage system; and
one or more programs, wherein the one or more programs are stored in the storage system and executed by the one or more processors, the one or more programs comprising:
a channel scanning module operable to actively scan a first wireless channel of the WLAN and wait for a first scanning result of the first wireless channel for a first waiting time period; and
a time extending module operable to transmit a first time extending frame to the first wireless channel to extend the first waiting time period;
wherein the channel scanning module further actively scans a second wireless channel of the WLAN within the first waiting time period, and waits for a second scanning result of the second wireless channel for a second waiting time period;
wherein the time extending module further transmits a second time extending frame to the second wireless channel to extend the second waiting time period.

2. The WLAN device as claimed in claim 1, wherein the channel scanning module further receives the first scanning result from the first wireless channel, and then receives the second scanning result from the second wireless channel, after the channel scanning module scans at least the first wireless channel and the second wireless channel.

3. The WLAN device as claimed in claim 2, wherein the first scanning result is a first probe response frame comprising a usage state of the first wireless channel, and the second scanning result is a second probe response frame comprising a usage state of the second wireless channel.

4. The WLAN device as claimed in claim 3, wherein the channel scanning module broadcasts a first probe request frame in the first wireless channel to actively scan the first wireless channel, and waits for the first probe response frame from the first wireless channel.

5. The WLAN device as claimed in claim 3, wherein the channel scanning module broadcasts a second probe request frame in the second wireless channel to actively scan the second wireless channel, and waits for the second probe response frame from the second wireless channel.

6. The WLAN device as claimed in claim 1, wherein the first time extending frame comprises a first duration field that loads a first occupied time period of how long the WLAN device occupies the first wireless channel, and the time extending module extends the first occupied time period so as to extend the first waiting time period.

7. The WLAN device as claimed in claim 6, wherein the second time extending frame comprises a second duration field that loads a second occupied time period of how long the WLAN device occupies the second wireless channel, and the time extending module extends the second occupied time period so as to extend the second waiting time period.

8. The WLAN device as claimed in claim 7, wherein the first time extending frame and the second time extending frame are selected from control frames and data frames defined by the IEEE 802.11 protocol.

9. A channel scanning method applied in a wireless local area network (WLAN) with a plurality of wireless channels, the channel scanning method comprising:
actively scanning a first wireless channel of the WLAN and waiting for a first scanning result of the first wireless channel for a first waiting time period;
transmitting a first time extending frame to the first wireless channel to extend the first waiting time period;
actively scanning a second wireless channel of the WLAN within the first waiting time period and waiting for a second scanning result of the second wireless channel for a second waiting time period;
transmitting a second time extending frame to the second wireless channel to extend the second waiting time period; and
executing the step of actively scanning the first wireless channel, the step of transmitting the first time extending frame, the step of actively scanning the second wireless channel, and the step of transmitting the second time extending frame using at least one processor.

10. The channel scanning method as claimed in claim 9, further comprising:
receiving the first scanning result from the first wireless channel after at least the first wireless channel and the second wireless channel have been scanned; and
receiving the second scanning result from the second wireless channel.

11. The channel scanning method as claimed in claim 10, wherein the first scanning result is a first probe response frame comprising a usage state of the first wireless channel, and the second scanning result is a second probe response frame comprising a usage state of the second wireless channel.

12. The channel scanning method as claimed in claim 11, wherein the block of actively scanning a first wireless channel and waiting for a first scanning result of the first wireless channel for a first waiting time period comprises:
broadcasting a first probe request frame in the first wireless channel to actively scan the first wireless channel; and
waiting for the first probe response frame from the first wireless channel for the first waiting time period.

13. The channel scanning method as claimed in claim 11, wherein the block of actively scanning a second wireless channel within the first waiting time period and waiting for a second scanning result of the second wireless channel for a second waiting time period comprises:
broadcasting a second probe request frame in the second wireless channel to actively scan the second wireless channel within the first waiting time period; and
waiting for the second probe response frame from the second wireless channel for the second waiting time period.

14. The channel scanning method as claimed in claim 9, wherein the first time extending frame comprises a first duration field that loads a first occupied time period of how long the first wireless channel is occupied.

15. The channel scanning method as claimed in claim 14, wherein the second time extending frame comprises a second duration field that loads a second occupied time period of how long the second wireless channel is occupied.

16. The channel scanning method as claimed in claim 15, wherein the first time extending frame and the second time extending frame are selected from control frames and data frames defined by the IEEE 802.11 protocol.

17. The channel scanning method as claimed in claim 14, wherein the block of transmitting a first time extending frame to the first wireless channel to extend the first waiting time period comprises:
extending the first occupied time period loaded by the first duration field so as to extend the first waiting time period.

18. The channel scanning method as claimed in claim 15, wherein the block of transmitting a second time extending frame to the second wireless channel to extend the second waiting time period comprises:
extending the second occupied time period loaded by the second duration field to extend the second waiting time period.
